(19) United States
(12) Patent Application Publication
(10) Pub. No.: US 2025/0080168 A1
(43) Pub. Date: Mar. 6, 2025

(54) Electronic Device with Dynamic Sensor Polling

(71) Applicant: Apple Inc., Cupertino, CA (US)

(72) Inventors: Haiyu Huang, San Jose, CA (US); Jorge L. Rivera Espinoza, Los Gatos, CA (US)

(21) Appl. No.: 18/773,883

(22) Filed: Jul. 16, 2024

Related U.S. Application Data
(60) Provisional application No. 63/579,902, filed on Aug. 31, 2023.

(51) Int. Cl. H04B 5/73; H04B 5/48

(52) U.S. Cl. CPC H04B 5/73; H04B 5/48

(57) ABSTRACT

An electronic device may include a sensor that performs object detection. The sensor may generate sensor data using a polling period. The device may include a neural network that receives the sensor data. The neural network may generate a likelihood score associated with detection of the object based on the sensor data. Control circuitry may adjust the polling period based on the likelihood score to balance power consumption with detection latency. As one example, the sensor may include near-field communications (NFC) circuitry coupled to a coil. The coil may transmit pulses of radio-frequency signals using the polling period. The coil may receive a waveform. The neural network may generate the likelihood score based on the waveform. The likelihood score may be used to detect an NFC device. The neural network may enable detection of subtle features in the waveform with minimal false detections.

This application claims the benefit of U.S. Provisional Patent Application No. 63/579,902, filed Aug. 31, 2023, which is hereby incorporated by reference herein in its entirety.

### FIELD

This disclosure relates generally to electronic devices, including electronic devices with sensor circuitry.

### BACKGROUND

Electronic devices often include sensors for sensing their surroundings. For example, cellular telephones, computers, and other devices often contain sensors that capture sensor data from the surrounding environment.

It can be challenging to provide electronic devices with sensors that exhibit sufficient levels of performance. For example, if care is not taken, the sensors can be inaccurate, can consume an excessive amount of power, or can exhibit excessive latency.

### SUMMARY

An electronic device may include a sensor that performs object detection. The sensor may generate sensor data using a polling period. The electronic device may include a neural network that receives the sensor data. The neural network may generate a likelihood score associated with detection of the object based on the sensor data. Control circuitry may adjust the polling period based on the likelihood score to improve detection latency without trading off power consumption.

As one example, the sensor may include near-field communications (NFC) circuitry operably coupled to a coil. The coil may periodically transmit radio-frequency signals using the polling period. The coil may periodically receive a waveform. The neural network may generate the likelihood score based on the waveform. The likelihood score may be used to detect an NFC-enabled device adjacent the coil. The neural network may enable detection of subtle features in the waveform with minimal false detections. The dynamic polling period may allow the neural network to detect a predetermined motion or gesture of the object such as a gesture associated with a transaction confirmation.

An aspect of the disclosure provides an electronic device. The electronic device can include a sensor configured to generate sensor data using a polling period. The electronic device can include a neural network configured to generate, based on the sensor data, an output indicative of an external object. The electronic device can include one or more processors configured to adjust the polling period based on the output of the neural network.

An aspect of the disclosure provides an electronic device. The electronic device can include a coil. The electronic device can include a near-field communications (NFC) transmitter operably coupled to the coil. The electronic device can include an NFC receiver operably coupled to the coil, the NFC receiver being configured to receive a radio-frequency waveform using the coil. The electronic device can include a neural network operably coupled to the NFC receiver and configured to generate a likelihood score based on the radio-frequency waveform. The electronic device can include one or more processors configured to detect an object based on the likelihood score.

An aspect of the disclosure provides a method of operating an electronic device. The method can include transmitting, using a coil, radio-frequency signals. The method can include receiving, using the coil, a waveform. The method can include generating, using a neural network, a likelihood score based on the received waveform, the likelihood score being associated with a near-field communications (NFC) device external to the electronic device. The method can include detecting, using one or more processors, a gesture associated with the NFC device based on a change in the likelihood score over time.

### BRIEF DESCRIPTION OF THE DRAWINGS

FIG. 1 is a diagram of an illustrative electronic device having a sensor that performs object detection using a neural network in accordance with some embodiments.

FIG. 2 is a diagram of an illustrative neural network in accordance with some embodiments.

FIG. 3 is a timing diagram showing how an illustrative sensor may perform object detection using a polling period that is dynamically adjusted based on the output of a neural network in accordance with some embodiments.

FIG. 4 is a flow chart of illustrative operations involved in performing object detection using a sensor having a polling period that is dynamically adjusted based on the output of a neural network in accordance with some embodiments.

FIG. 5 is a diagram showing how an illustrative electronic device may include a near-field communications (NFC) sensor that conveys radio-frequency signals with an external NFC device in accordance with some embodiments.

FIG. 6 is a circuit diagram of an illustrative NFC sensor having a polling period that is dynamically adjusted based on the output of a neural network in accordance with some embodiments.

FIG. 7 is a diagram showing how an illustrative neural network may be updated using offline training data in accordance with some embodiments.

FIG. 8 is a diagram showing how an illustrative neural network may be updated using online training data in accordance with some embodiments.

FIG. 9 is a timing diagram showing how an illustrative sensor may detect a predetermined gesture based on the output of a neural network and a sensor having a polling period that is adjusted based on the output of the neural network in accordance with some embodiments.

FIG. 10 is a flow chart of illustrative operations that may be performed by an illustrative sensor to detect a predetermined gesture based on the output of neural network in accordance with some embodiments.

### DETAILED DESCRIPTION

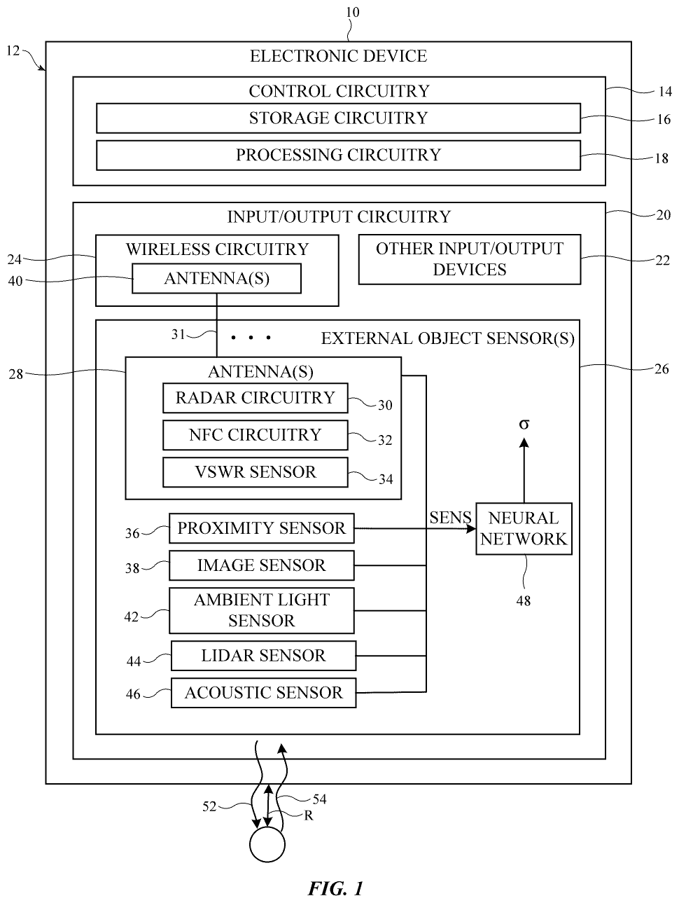

FIG. 1 is a diagram of an illustrative device 10. Device 10 is an electronic device and may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head (e.g., a virtual, mixed, or augmented reality headset device), or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a point of sale terminal, a remote control device, a gaming controller, a peripheral user input device, a wireless base station or access point, equipment that implements the functionality of two or more of these devices, or other electronic equipment. Device 10 is sometimes also referred to herein as electronic device 10 or user equipment (UE) device 10.

As shown in the functional block diagram of FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols-sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), near-field communications (NFC) protocols, antenna-based spatial ranging protocols, optical communications protocols, or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices such as input-output devices 22. Input-output devices in input-output circuitry 20 may be used to allow data to be supplied to device 10 and/or to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link). The input-output devices in input-output circuitry 20 may also include one or more external object detecting sensors such as external object sensors 26.

Input-output circuitry 20 may include wireless circuitry 24 to support wireless communications. Wireless circuitry 24 (sometimes referred to herein as wireless communications circuitry 24) may include one or more antennas 40. Wireless circuitry 24 may also include transceiver circuitry (not shown). The transceiver circuitry may include transmitter circuitry, receiver circuitry, modulator circuitry, demodulator circuitry (e.g., one or more modems), one or more radios, radio-frequency circuitry, one or more radios, intermediate frequency circuitry, optical transmitter circuitry, optical receiver circuitry, optical light sources, other optical components, baseband circuitry (e.g., one or more baseband processors), amplifier circuitry, clocking circuitry such as one or more local oscillators and/or phase-locked loops, memory, one or more registers, filter circuitry, switching circuitry, analog-to-digital converter (ADC) circuitry, digital-to-analog converter (DAC) circuitry, radio-frequency transmission lines, optical fibers, and/or any other circuitry for transmitting and/or receiving wireless signals using antennas 40. The components of the transceiver circuitry may be implemented on one integrated circuit, chip, system-on-chip (SOC), die, printed circuit board, substrate, or package, or the components of the transceiver circuitry may be distributed across two or more integrated circuits, chips, SOCs, printed circuit boards, substrates, and/or packages.

Each antenna 40 may be fed over a respective signal path 31. Each signal path 31 may include one or more radio-frequency transmission lines, waveguides, optical fibers, and/or any other desired lines/paths for conveying wireless signals between transceiver circuitry in wireless circuitry 24 and antenna 40. If desired, one or more signal paths 31 may couple one or more antennas 40 to one or more radio-frequency sensor(s) 28 in external object sensor(s) 26. While illustrated as a part of external object sensor(s) 26 in FIG. 1 for the sake of clarity, radio-frequency sensor(s) 28 may also form a part of wireless circuitry 24.

Antennas 40 may be formed using any desired antenna structures for conveying wireless signals. For example, antennas 40 may include antennas with resonating elements that are formed from dipole antenna structures, planar dipole antenna structures (e.g., bowtie antenna structures), slot antenna structures, loop antenna structures, patch antenna structures, inverted-F antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antennas 40 over time.

While control circuitry 14 is shown separately from wireless circuitry 24 and external object sensor(s) 26 in the example of FIG. 1 for the sake of clarity, wireless circuitry 24 and/or external object sensor(s) 26 may include processing circuitry (e.g., one or more processors) that forms a part of processing circuitry 18 and/or storage circuitry that forms a part of storage circuitry 16 of control circuitry 14 (e.g., portions of control circuitry 14 may be implemented on wireless circuitry 24 and/or external object sensor(s) 26). As an example, control circuitry 14 may include baseband circuitry (e.g., one or more baseband processors), digital control circuitry, analog control circuitry, one or more neural networks, and/or other control circuitry that forms part of wireless circuitry 24 and/or external object sensor(s) 26. The baseband circuitry may, for example, access a communication protocol stack on control circuitry 14 (e.g., storage circuitry 16) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

If desired, two or more of antennas 40 may be integrated into a phased antenna array (sometimes referred to herein as a phased array antenna or an array of antenna elements) in which each of the antennas conveys wireless signals with a respective phase and magnitude that is adjusted over time so the wireless signals constructively and destructively interfere to produce (form) a signal beam in a given pointing direction. The term “convey wireless signals” as used herein means the transmission and/or reception of the wireless signals (e.g., for performing unidirectional and/or bidirectional wireless communications with external wireless communications equipment). Antennas 40 may transmit the wireless signals by radiating the signals into free space (or to free space through intervening device structures such as a dielectric cover layer). Antennas 40 may additionally or alternatively receive the wireless signals from free space (e.g., through intervening devices structures such as a dielectric cover layer). The transmission and reception of wireless signals by antennas 40 each involve the excitation or resonance of antenna currents on an antenna resonating (radiating) element in the antenna by the wireless signals within the frequency band(s) of operation of the antenna.

Transceiver circuitry in wireless circuitry 24 may use antenna(s) 40 to transmit and/or receive wireless signals that convey wireless communications data between device 10 and external wireless communications equipment (e.g., one or more other devices such as device 10, a wireless access point or base station, etc.). The wireless communications data may be conveyed bidirectionally or unidirectionally. The wireless communications data may, for example, include data that has been encoded into corresponding data packets such as wireless data associated with a telephone call, streaming media content, internet browsing, wireless data associated with software applications running on UE device 10, email messages, etc.

Wireless circuitry 24 (e.g., antenna(s) 40) may transmit and/or receive wireless radio-frequency signals within corresponding frequency bands of the electromagnetic spectrum (sometimes referred to herein as communications bands or simply as “bands”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHZ), a 5 GHz WLAN band (e.g., from 5180 to 5825 MHZ), a Wi-Fi® 6E band (e.g., from 5925-7125 MHZ), and/or other Wi-Fi® bands (e.g., from 1875-5160 MHZ), wireless personal area network (WPAN) frequency bands such as the 2.4 GHz Bluetooth® band or other WPAN communications bands, cellular telephone frequency bands (e.g., bands from about 600 MHz to about 5 GHZ, 3G bands, 4G LTE bands, 5G New Radio Frequency Range 1 (FR1) bands below 10 GHz, 5G New Radio Frequency Range 2 (FR2) bands between 20 and 60 GHZ, cellular sidebands, 6G bands between 100-1000 GHZ (e.g., sub-THz, THz, or THF bands), etc.), other centimeter or millimeter wave frequency bands between 10-300 GHz (e.g., a short range wireless data transfer band that supports in-band full duplex communications such as a band between around 57 GHz and 64 GHZ), near-field communications (NFC) frequency bands (e.g., at 13.56 MHZ), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, industrial, scientific, and medical (ISM) bands such as an ISM band between around 900 MHZ and 950 MHz or other ISM bands below or above 1 GHZ, one or more unlicensed bands, one or more bands reserved for emergency and/or public services, and/or any other desired frequency bands of interest. Wireless circuitry 24 may also be used to perform spatial ranging operations if desired. Different antennas 40 may cover one or more than one of any of these bands. If desired, some antennas 40 may be used to cover a first set of one or more bands whereas a second antenna 40 is used to cover a second set of one or more bands.

External object sensor(s) 26 may include sensors that are used to perform external object detection on one or more external objects such as object 50. As used herein, object detection involves the detection, monitoring, measurement, or sensing, by external object sensor 26, of a predetermined characteristic of object 50. The predetermined characteristic may be the presence or absence of object 50 (e.g., at or adjacent to device 10, at a particular position relative to device 10, at an expected position, etc.), the location, position, velocity, speed, movement, rotation, and/or orientation of object 50 (e.g., over time), the distance (range) R between device 10 and object 50, that object 50 is an expected or particular type of object as opposed to another type of object (e.g., to verify or authenticate that object 50 is a particular object instead of a different object, that object 50 is formed from a particular material and not another material, etc.), a particular motion or movement of object 50 (e.g., a gesture or action performed by object 50 that matches a predetermined gesture or action), or any other information associated with object 50. Object 50 is sometimes referred to herein as external object 50.

Object 50 may be, for example, some or all of the body of a user of device 10 or another human or animal (e.g., a human hand, head, leg, or other body part), another device 10, a radio-frequency identification (RFID) or NFC tag (e.g., a credit card having an integrated NFC chip and antenna), an RFID or NFC tag reader, a device having NFC and/or RFID functionality, a point of sale (POS) terminal, a peripheral or accessory device such as a stylus, gaming controller, keyboard, mouse, etc., a tabletop, a desktop, furniture, a wall, a ceiling, the ground, a vehicle, a potential hazard, a metal object, a dielectric object, an animate object, an inanimate object, an object subject to regulatory requirements on emitted or absorbed radio-frequency energy, an object not subject to regulatory requirements on emitted or absorbed radio-frequency energy, a wristwatch device, a headset device, headphones, a kiosk, or any other object external to device 10.

In performing object detection, control circuitry 14 may use the detected predetermined characteristic (e.g., presence, location, orientation, velocity, etc.) of object 50 to perform any desired device operations. As examples, control circuitry 14 may use the detected characteristic to identify a corresponding user input for one or more software applications running on device 10 such as a gesture input performed by the user's hand(s) or other body parts or performed by an external stylus, gaming controller, head-mounted device, or other peripheral devices or accessories, to determine when one or more antennas 40 needs to be disabled or provided with a reduced maximum transmit power level (e.g., for satisfying regulatory limits on radio-frequency exposure), to determine how to steer (form) a radio-frequency signal beam produced by antennas 40 for wireless circuitry 24 (e.g., in scenarios where antennas 40 include a phased array of antennas), to map or model the environment around device 10 (e.g., to produce a software model of the room where device 10 is located for use by an augmented reality application, gaming application, map application, home design application, engineering application, etc.), to detect the presence of obstacles or hazards in the vicinity of (e.g., around) device 10 or in the direction of motion of the user of device 10, to perform or confirm a transaction such as a financial transaction between device 10 or a user of device 10 and object 50 or a user of object 50, etc.

External object sensor(s) 26 may include any desired object detecting sensors that produce corresponding sensor data SENS while performing object detection on object 50. For example, external object sensor(s) 26 may include radio-frequency sensor(s) 28, a proximity sensor such as proximity sensor 36, light-based sensors such as image sensor 38, ambient light sensor 42, proximity sensor 36, and/or light detection and ranging (LiDAR) sensor 44, acoustic-based sensors such as acoustic sensor 46, and/or any other desired sensors that perform object detection on object 50. External object sensor(s) 26 may perform object detection on object 50 using a signal 52 that is transmitted and/or produced by device 10 (e.g., towards object 50) and/or using a signal 54 that is received by device 10 (e.g., from object 50). Signals 52 and 54 may include electromagnetic signals (e.g., a dynamic electromagnetic signal that varies as a function of time and/or space, a static or changing electric field, a static or changing magnetic field, changes in capacitance, changes in impedance, optical signals such as light at visible, ultraviolet, near-infrared, and/or infrared wavelengths, etc.), acoustic signals, or other signals.

External object sensor(s) 26 may perform object detection by performing polling (e.g., using signal 52 and/or signal 54). When performing polling, an external object sensor 26 polls signal 52 (e.g., transmits one or more pulses of signal 52) and/or signal 54 (e.g., receives one or more pulses of signal 54). The external object sensor polls signals 52 and/or 54 using a corresponding polling period defined by the time between polls (e.g., between pulses of signal 52 and/or signal 54). The polling period has an associated polling frequency (e.g., the frequency of the polls).

The external object sensor may be active or operating at greater than a threshold activity level (e.g., consuming more than a threshold amount of power, consuming a peak amount of power, etc.) while signals 52 and/or 54 are polled/pulsed. The external object sensor may be inactive or operating at less than the threshold activity level (e.g., consuming less than threshold amount of power, consuming a minimum amount of power, etc.) while signals 52 and/or 54 are not being polled/pulsed (e.g., between polls/pulses). If desired, the external object sensor may be asleep or powered off when not being polled/pulsed to conserve power. In general, lower polling periods (higher polling frequencies) may allow the external object sensor to perform object detection on object 50 more quickly (e.g., with less latency) than higher polling periods (lower polling frequencies). On the other hand, higher polling periods (lower polling frequencies) may allow the external object sensor to perform object detection on object 50 more quickly (e.g., with less latency) than higher polling periods (lower polling frequencies).

Radio-frequency sensor(s) 28 may include NFC circuitry 32, radio detection and ranging (radar) circuitry 30, voltage standing wave ration (VSWR) sensor 34, and/or any other desired sensors that perform object detection on object 50 using radio-frequency signals conveyed over one or more antennas 40. As such, radio-frequency sensor(s) 28 may be coupled top one or more antennas 40 over one or more signal paths 31.

Radar circuitry 30 may perform object detection by transmitting signal 52 as radio-frequency signals (e.g., radar signals, chirp signals, frequency ramps, etc.) and receiving signal 54 as a reflected version of the radio-frequency signals that have reflected off external object 50. Radar circuitry 30 may process the timing and/or frequency of the transmitted and received radio-frequency signals to detect object 50. Radar circuitry 30 may transmit radio-frequency signals using any desired radar scheme (e.g., an orthogonal frequency division multiplexing (OFDM) radar scheme, a frequency modulated continuous wave (FMCW) radar scheme, etc.). When polled, radar circuitry 30 may transmit a segment, pulse, or other discrete amount of radio-frequency signals in signal 52 and may receive a corresponding segment, pulse, or other discrete amount of reflected radio-frequency signals in signal 54, for example. Between polls, radar circuitry 30 may forego signal transmission and/or reception to conserve power, if desired. Radar circuitry 30 is sometimes also referred to herein as radar sensor 30.

VSWR sensor 34 may measure the VSWR, scattering parameters, and/or impedance of one or more antennas 40 based on radio-frequency signals transmitted over the antenna(s). VSWR sensor 45 may include, for example, one or more directional couplers (e.g., switch couplers) disposed along a corresponding signal path 31, a power detector, a feedback receiver, etc. Measurements performed by VSWR sensor 34 may be used to perform object detection on object 50 (e.g., because the presence of object 50 at or adjacent antenna(s) 40 effectively load the impedance of antenna(s) 40 in a manner that is detected by VSWR sensor 34). When polled, VSWR sensor 34 may gather a measurement from radio-frequency signals transmitted using antenna(s) 40 (e.g., signal 52 may include the radio-frequency signals transmitted by antenna(s) 40 and/or signal 54 may include a change in impedance produced at antenna(s) 40 by object 50). Between polls, antenna(s) 40 may forego signal transmission and/or reception to conserve power, if desired.

NFC circuitry 32 may be coupled to one or more antenna(s) 40 over one or more signal paths 31. The antenna(s) 40 coupled to NFC circuitry 32 may include a loop antenna formed from one or more loops, coils, or windings of conductive material. NFC circuitry 32 may include an NFC transmitter, an NFC receiver, and/or an NFC controller coupled to the loop antenna. The loop antenna may transmit radio-frequency signals in signal 52 (e.g., within an NFC band) and/or may receive radio-frequency signals in signal 54 (e.g., within the NFC band). NFC circuitry 32 may perform object detection by detecting and processing the transmitted and/or received radio-frequency signals. For example, NFC circuitry 32 may perform object detection by measuring an impedance response of the received radio-frequency signals as produced by object 50 in response to the transmitted radio-frequency signals. When polled, NFC circuitry 32 may transmit a segment, pulse, or other discrete amount of radio-frequency signals in signal 52 (e.g., in the NFC band) and may receive a corresponding segment, pulse, or other discrete amount of radio-frequency signals in signal 54, for example. Between polls, NFC circuitry 32 may forego signal transmission and/or reception to conserve power, if desired. The antenna(s) 40 used by NFC circuitry 32 may include a dedicated NFC antenna used to convey NFC data, may be used to perform wireless charging of device 10 and/or object 50 (e.g., may be a wireless charging coil), and/or may convey both NFC data and non-NFC data (e.g., may be a cellular telephone antenna that is also configured to convey NFC signals).

Proximity sensor 36 may include capacitive proximity sensors, light-based proximity sensors (e.g., infrared proximity sensors based on transmitted infrared light in signal 52 and received infrared light in signal 54), and/or any other desired sensors that detect the proximity of object 50 relative to device 10. For example, when implemented as a capacitive proximity sensor, proximity sensor 36 may include one or more capacitor electrodes or plates. The capacitance of the electrode(s) will change based on the distance R between object 50 and the electrode(s). Proximity sensor 36 may perform object detection on object 50 by detecting or measuring the capacitance. When polled, the electrode(s) may be driven and the capacitance of the electrode(s) may be measured (e.g., signal 54 may be a capacitance change on the electrode(s) as produced by object 50). Between polls, proximity sensor 36 may forego driving the electrode(s) and/or measuring the capacitance to conserve power, if desired.

Image sensor 38 may include an array of image sensor pixels that generate image sensor data in response to light (e.g., light in signal 54). Image sensor 38 may include a camera, for example. When polled, image sensor 38 may capture image sensor data (e.g., one or more images) of the surroundings, including objects such as object 50. Between polls, image sensor 38 may forego capturing or generating image sensor data to conserve power, if desired.

Ambient light sensor 42 may generate electrical signals (ambient light sensor data) indicative of an ambient light level around device 10. When polled, ambient light sensor 42 may capture ambient light level values from the surroundings (e.g., in signal 54). Between polls, ambient light sensor 42 may forego capturing or generating ambient light sensor data to conserve power, if desired.

LiDAR sensor 44 may include one or more optical emitters and one or more optical sensors. The optical emitters may transmit one or more beams of light in signal 52 onto the surroundings of device 10 (including object 50). The optical sensors may receive reflected versions of the one or more beams of light (in signal 54) as reflected off the environment (including object 50). LiDAR sensor 44 may process the transmitted and received beams of light to spatially map the surroundings of device 10, to detect the distance between device 10 and different points in the surroundings (e.g., object 50), etc. When polled, the optical emitters may emit the beam(s) of light and the optical sensors may capture optical sensor data (e.g., one or more images) of the reflected beam(s) of light, including from objects such as object 50. Between polls, the optical emitters may forego emission of the beam(s) of light and the optical sensors may forego measurement of the reflected beam(s) of light to conserve power, if desired.

Acoustic sensor 46 may include an audio sensor such as a microphone, a vibration sensor, an acoustic-based ranging sensor, an ultrasonic sensor, and/or other acoustic sensors. Acoustic sensor 46 may gather audio data from sounds produced around device 10 (e.g., using a microphone that measures acoustic signals in signal 54). Additionally or alternatively, acoustic sensor 46 may transmit sound waves (e.g., at ultrasonic frequencies) in signal 52 and may receive a reflected version of the transmitted sound waves in signal 54. Acoustic sensor 46 may process the transmitted and received sound waves to detect the distance between device 10 and other objects around device 10, such as object 50.

External object sensor(s) 26 may include one, more than one, or all of sensors 28, 36, 38, 42, 44, and 46. External object sensor(s) 26 may generate corresponding sensor data SENS while performing object detection. Sensor data SENS may include sensor data indicative of one or more predetermined characteristics of object 50 (e.g., of the detection of object 50). Sensor data SENS may include, for example, sensor data generated, measured, or gathered by radar circuitry 30 (e.g., ranging information, transmitted and/or received radio-frequency waveforms, etc.), sensor data generated by NFC circuitry 32 (e.g., NFC data modulated onto received radio-frequency signals by object 50, received waveforms, etc.), sensor data generated by VSWR sensor 34 (e.g., VSWR values, scattering parameter values, reflection coefficient values, impedance values, etc.), proximity sensor data generated by proximity sensor 36 (e.g., capacitance values, optical proximity sensor data, etc.), image sensor data generated by image sensor 38, ambient light sensor data generated by ambient light sensor 42, sensor data generated by LiDAR sensor 44, sensor data generated by acoustic sensor 46, etc.

As shown in FIG. 1, external object sensor(s) may include an artificial intelligence (AI) or machine learning (ML) system (model) such as neural network 48 (e.g., an artificial neural network such as a deep neural network) for optimizing the generation of sensor data SENS (e.g., in a manner that minimizes power consumption and/or latency by external object sensor(s) 26 while performing object detection on object 50). Neural network 48 may, for example, generate a neural network output based on sensor data SENS that is indicative of the detection of object 50. In an implementation that is described herein as an example, the neural network output includes a likelihood score σ. Likelihood score σ is a numerical value that represents the probability that external object 50 has been detected (e.g., with the predetermined characteristic) by external object sensor(s) 26.

For example, likelihood score σ may represent the likelihood that object 50 is present at or near device 10, that object 50 is at a particular location, position, and/or orientation (e.g., relative to device 10), that object 50 is at a particular distance R from device 10, that object 50 is a particular, authentic, or expected type of device as opposed to a different type of device (e.g., an NFC device or RFID tag as opposed to a foreign object such as a metal object without NFC/RFID capabilities), that object 50 is performing a particular movement (e.g., gesture), that object 50 has a particular velocity, speed, motion, or movement, that object 50 is animate, that object 50 is inanimate, etc. Likelihood score σ may be a discrete good-vs-bad output (e.g., having a value of either 1.0, indicative of a first object detection result or 0, indicative of a second object detection result) or a continuous regression-based output (e.g., from 0 to 1.0, indicative of a range of object detection results). Likelihood score σ is sometimes also referred to herein as likelihood value σ, strength value σ, strength score σ, likelihood σ, or strength σ.

Control circuitry 14 may perform any desired operations based on likelihood score σ. Neural network 48 may form part of or may be replaced by any desired machine learning model (e.g., a model that uses techniques such as the quantile regression, the delta method, Bayesian neural networks, dropout, bootstrapping, and/or quantile analysis). Neural network 48 may be implemented in hardware (e.g., using one or more processors, one or more digital and/or analog logic gates, baseband circuitry, an application specific integrated circuit, etc.) and/or software (e.g., an application processor).

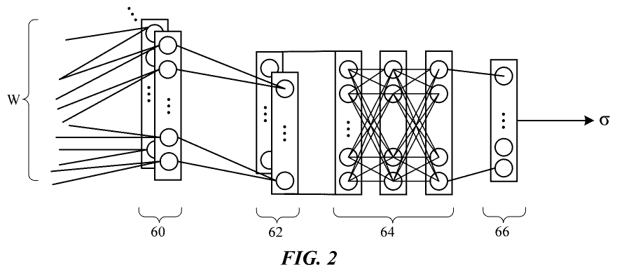

FIG. 2 is a schematic diagram of an illustrative neural network 48 (e.g., in an implementation in which neural network 48 is a deep convolutional neural network (CNN)). As shown in FIG. 2, neural network 48 may have a corresponding weight function W (e.g., a set or matrix of weights, each associated with a different respective link or combination of paths between the nodes/kernels of neural network 48).

Neural network 48 may include a convolutional layer 60 (e.g., a one-dimensional convolutional layer) having inputs that receive sensor data SENS (FIG. 1). Convolutional layer 60 may be trained using training data. Convolutional layer 60 may have a number of nodes (kernels) equal to the number of outputs of the layer. Each kernel may be trained to represent one feature contained within the input data (e.g., sensor data SENS). As such, the more kernels in the layer, the more complex the information that can be extracted by the neural network.

The outputs of convolutional layer 60 are coupled to the inputs of pooling layer 62. The outputs of pooling layer 62 are coupled to the inputs of dense layers 64 (e.g., where each node/kernel of a given dense layer 64 is coupled to every node of the previous and subsequent dense layer 64). The outputs of dense layers 64 are coupled to the input of decision logic such as final classifier stage 66. Final classifier stage 66 outputs, based on the sensor data SENS input to neural network 48, a corresponding likelihood score σ (e.g., a softmax output). In implementations where neural network 48 outputs a discrete likelihood score σ of either 0 (e.g., corresponding to no object detected) or 1 (e.g., corresponding to an object being detected), all layers may have a non-linear activation function of simplified rectified linear unit (ReLu) and likelihood score σ may be represented by σ(z)=softmax(ReLu(z)), where ReLu(z)=max(0,z) (e.g., without requiring a sigmoid).

In general, final classifier stage 66 has an output array size that represents the number of classes for the particular use case of the neural network. Each element in the output array is a likelihood score, generally scaled from 0 to 1. In a simplest example, final classifier stage 66 outputs a binary classification with only two classes (e.g., no object detected vs. object detected, RFID/NFC tag detected vs. not detected, external object exhibits predetermined characteristic vs. does not exhibit predetermined characteristic, etc.) and is equal to either zero (when the first class is detected) or one (when the second class is detected). Each layer except for the pooling layer may contain some non-linear activation function. For example, a ReLu function can be used as the activation on all layers. In general, each output node represents one class (e.g., object or non-object for a binary class), the likelihood score for a class j in a neural network is softmax(zⱼ), which itself serves as the non-linear activation function for the final layer of the neural network. Here, if also using ReLu for the final layer, the calculation of the likelihood score can be given be σ(zⱼ)=ReLu(zⱼ)/(SUM(ReLu(zⱼ)+ε)). Because ReLu(zⱼ) can be 0, factor ε is added to prevent the denominator from becoming 0. Alternatively, softmax can be applied on top of ReLu, simplifying the formula to σ(zⱼ)=softmax(ReLu(zⱼ)). Either formula will produce an output bounded between 0 and 1. During training of neural network 48, a training loss function Loss (ReLu(z)) may be used instead of likelihood score.

The deep CNN example shown in FIG. 2 may be optimal for situations where sensor data SENS is a one-dimensional signal (e.g., a time series having a magnitude that varies as a function of time), such as when sensor data SENS is an NFC waveform received by NFC circuitry 32. This is illustrative and, in general, neural network 48 may include multiple neural networks coupled together in series and/or in parallel and/or may be implemented using any desired neural network and/or machine learning architecture.

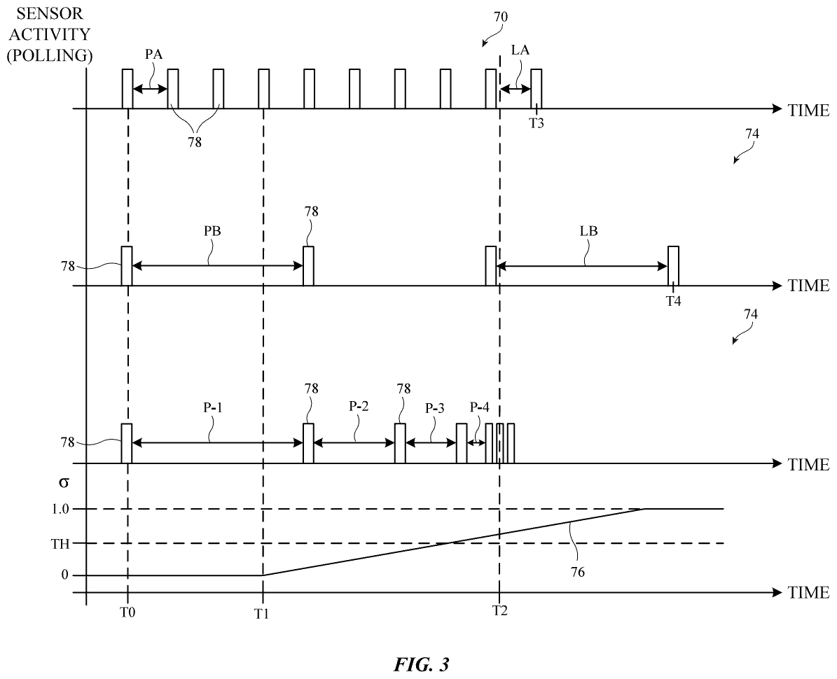

A given external object sensor 26 may perform polling. When polled, the external object sensor generates a segment or portion of sensor data SENS. The segment of sensor data SENS is provided to neural network 48. Neural network 48 produces an output based on the segment of sensor data. To minimize latency and/or power consumption by external object sensor 26 in performing object detection, control circuitry 14 (FIG. 1) may dynamically adjust the polling period of the external object sensor over time based on the output of neural network 48 produced in response to sensor data SENS. FIG. 3 is a timing diagram showing how the polling period of a given external object sensor 26 may be dynamically adjusted based on the output of neural network 48 (e.g., based on likelihood score σ).

Curve 76 of FIG. 3 plots the output of neural network 48 (e.g., likelihood score σ) as a function of time while external object sensor 26 performs object detection. Over time, one or more characteristics of object 50 changes relative to device 10. Likelihood score σ varies from a value of around 0, in which object 50 certainly does not exhibit a predetermined characteristic to a value of around 1.0, in which object 50 certainly does exhibit the predetermined characteristic. The predetermined characteristic may be presence at a certain position relative to device 10 (e.g., at or within a particular distance R), movement with a particular velocity, an identification that object 50 is a particular type of object (e.g., that object 50 is an RFID tag or NFC device as opposed to a metallic object without RFID/NFC functionality), movement of object 50 consistent with a predetermined gesture, etc.

Pulses 78 of FIG. 3 represent times at which external object sensor 26 is polled (e.g., times at which external object sensor 26 is active, pulsed, transmits a signal 52, receives a signal 54, etc.). Pulses 78 are sometimes also referred to herein as polls 78. External object sensor 26 may be inactive between pulses 78 or may be less active between pulses 78 than during pulses 78. External object sensor 26 gathers a respective segment (portion) of sensor data SENS during each pulse 78 and does not gather sensor data SENS between pulses 78. Each segment of sensor data SENS is input to neural network 48, which outputs a corresponding likelihood score σ (or another neural network output) based on the segment of sensor data SENS. In this way, each pulse 78 may correspond to a respective likelihood score output by neural network 48.

As one or more characteristics of object 50 change over time such that it becomes more likely that object 50 exhibits the predetermined characteristic, likelihood score σ will begin to increase. For example, once the one or more characteristics have changed by more than a threshold amount (e.g., once object 50 has moved to within a threshold distance R from device 10), likelihood score σ begins to increase from zero (e.g., at time T1). Decision logic in neural network 48 may compare likelihood score σ to a predetermined threshold likelihood score TH (e.g., 0.5, 0.7, 0.8, 0.9, 0.99, etc.). Threshold likelihood score TH represents a likelihood score with which device 10 is sufficiently confident that the sensed object exhibits the predetermined characteristic. Once likelihood score σ has reached threshold likelihood score TH (e.g., at time T2), external object sensor 26 may output an object detection signal or indication identifying that object 50 has been detected or otherwise exhibits the predetermined characteristic.

Plot 70 of FIG. 3 plots the activity of external object sensor 26 as a function of time in an implementation where external object sensor 26 is polled using a relatively low (short) polling period PA (or equivalently a relatively high polling frequency). As shown by plot 70, external object sensor 26 is polled using pulses 78 that are separated in time by polling period PA. After time T2, the next pulse 78 of external object sensor 26 produces sensor data SENS that causes neural network 48 to output a likelihood score σ greater than threshold likelihood score TH and external object sensor 26 outputs a detection signal or indication identifying that object 50 has been detected or otherwise exhibits the predetermined characteristic (e.g., that object 50 is an NFC device or RFID tag and not a metallic object without NFC capabilities, that object 50 is present at or adjacent device 10, etc.).

Since polling period PA is relatively short, there is a relatively low latency LA between time T2 and when device 10 outputs the detection signal (e.g., time T3). Once the detection signal has been output, external object sensor 26 may, if desired, enter a full power mode (e.g., after time T3). In the full power mode, the external object sensor may continuously transmit signal 52 (FIG. 1) and/or may continuously receive signal 54 (FIG. 1) (e.g., may continuously gather sensor data for detecting object 50, may perform higher power sensing on object 50, may perform radio-frequency communications with object 50, etc.). On the other hand, external object sensor 26 is polled relatively frequently prior to time T2, causing external object sensor 26 and thus device 10 to consume an excessive amount of power, which can limit battery life and/or produce excessive thermal heating of device 10.

Plot 72 of FIG. 3 plots the activity of external object sensor 26 as a function of time in an implementation where external object sensor 26 is polled using a relatively high (long) polling period PB (or equivalently a relatively low polling frequency). As shown by plot 72, external object sensor 26 is polled using pulses 78 that are separated in time by polling period PB. This causes neural network 48 to output a likelihood score σ greater than threshold likelihood score TH with a relatively high latency LB after time T2 (e.g., much higher than latency LA). In other words, while the reduced polling period PB in plot 72 consumes less power than the increased polling period PA in plot 70, polling period PB causes external object sensor 26 to exhibit excessively high latency in producing the object detection signal (e.g., at time T4 which is later than time T3). Polling using polling period PA is sometimes referred to herein as high power polling. Polling using polling period PB is sometimes referred to herein as low power polling. Once the detection signal has been output, external object sensor 26 may, if desired, enter a full power mode (e.g., after time T4). In the full power mode, the external object sensor may continuously transmit signal 52 (FIG. 1) and/or may continuously receive signal 54 (FIG. 1) (e.g., may continuously gather sensor data for detecting object 50, may perform higher power sensing on object 50, may perform radio-frequency communications with object 50, etc.).

To achieve low latency and low power consumption, control circuitry 14 (FIG. 1) may dynamically adjust the polling period P of external object sensor 26 as a function of the output of neural network 48 (e.g., as a function of likelihood score σ). Plot 74 of FIG. 3 plots the activity of external object sensor 26 as a function of time in an implementation where external object sensor 26 is polled using a dynamic polling period that is adjusted based on likelihood score σ.

As shown by plot 74, external object sensor 26 is polled using pulses 78 that are separated in time by a relatively long polling period P-1 while likelihood score σ is close to zero (e.g., 0.02 or less, 0.05 or less, 0.01 or less, etc.). This serves to minimize power consumption on device 10. Once likelihood score σ begins to increase (e.g., at time T1), control circuitry 14 may begin to decrease polling period P (e.g., the separation in time between pulses 78). For example, control circuitry 14 may decrease polling period P to polling period P-2 and then to polling periods P-3 and P-4 as likelihood score σ continues to increase (e.g., polling period P may be inversely proportional to likelihood score σ or, equivalently, polling frequency may be directly proportional to likelihood score σ). Once likelihood score σ increases above threshold likelihood score TH, external object sensor 26 outputs an object detection signal (e.g., at or just after time T2). Once the detection signal has been output, external object sensor 26 may, if desired, enter a full power mode (e.g., after time T2). In the full power mode, the external object sensor may continuously transmit signal 52 (FIG. 1) and/or may continuously receive signal 54 (FIG. 1) (e.g., may continuously gather sensor data for detecting object 50, may perform higher power sensing on object 50, may perform radio-frequency communications with object 50, etc.).

Since polling period P decreases as likelihood score σ increases, external object sensor 26 is able to minimize the latency of external object sensor 26 (e.g., the amount of time after time T2 before external object sensor 26 outputs the object detection signal) to less than latency LA and much less than latency LB, thereby also reducing the amount of time before the sensor enters a full power mode when applicable. By using longer polling periods while likelihood score σ is relatively low, external object sensor 26 is able to minimize power consumption during times when it is extremely unlikely for object 50 to exhibit the predetermined characteristic.

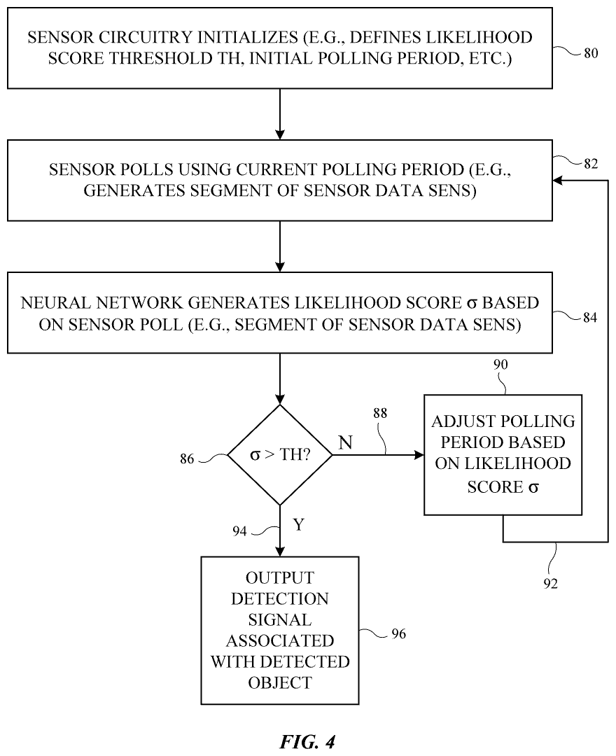

FIG. 4 is a flow chart of operations that may be performed by device 10 to perform object detection using an external object sensor 26 with a polling period P that is dynamically adjusted based on the output of neural network 48 (e.g., likelihood score σ).

At operation 80, external object sensor 26 may initialize. This may involve the definition or selection (e.g., in software and/or hardware) of a threshold likelihood score TH for neural network 48, an initial polling period P, etc.

At operation 82, external object sensor 26 may poll using the current or selected polling period P (e.g., pulses 78 of FIG. 3). The poll (pulse) of external object sensor 26 may produce a corresponding segment of sensor data SENS. The segment of sensor data SENS may be provided to the input of neural network 48.

At operation 84, neural network 48 may generate an output such as likelihood score σ based on the poll of external object sensor 26 (e.g., based on segment of sensor data SENS). Neural network 84 may generate the likelihood score based on a single poll of external object sensor 26 or based on multiple polls of external object sensor 26. For example, the neural network may generate the likelihood score based on a set of one or more polls, where the set includes the most recent poll, one or more polls prior to the most recent poll (e.g., an average of the one or more polls prior to the most recent poll), or the most recent poll and one or more polls prior to the most recent poll (e.g., an average of the most recent poll and the one or more polls prior to the most recent poll). Put differently, neural network 48 may generate likelihood score σ as a combination (e.g., average) of multiple likelihood scores generated for one or more polls including the current pole and/or one or more previous polls (e.g., likelihood score σ may be a combination or average of likelihood scores for a current or most recent poll and/or one or more previous polls or iterations of the operations of FIG. 4).

At operation 86, control circuitry 14 may determine, detect, or identify whether the output of neural network 48 (e.g., likelihood score σ) exceeds threshold likelihood score TH. If/when the output of neural network 48 does not exceed threshold likelihood score TH, processing proceeds to operation 90 via path 88.

At operation 90, control circuitry 14 controls external object sensor 26 to adjust polling period P for one or more subsequent polls based on the output of neural network 48 (e.g., likelihood score σ which may, if desired, be a combination or average of multiple likelihood scores generated based on a set of one or more polls including the most recent poll and/or one or more previous polls). For example, if/when likelihood score σ has increased relative to one or more previous (earlier) polls of external object sensor 26 (e.g., one or more previous iterations of operations 82-90), this may be indicative of external object 50 coming closer to exhibiting the predetermined characteristic and control circuitry 14 may decrease polling period P (or increase polling frequency) for one or more subsequent polls (e.g., for the next poll, the next two polls, the next ten polls, etc.) to maximize the chance that the next poll(s) will produce a likelihood score greater than threshold likelihood score TH (thereby minimizing the latency of external object sensor 26 in detecting object 50). On the other hand, if/when likelihood score σ has decreased relative to one or more previous polls of external object sensor 26 (e.g., one or more previous iterations of operations 82-90), this may be indicative of external object 50 moving farther from exhibiting the predetermined characteristic and control circuitry 14 may increase polling period P (or decrease polling frequency) for one or more subsequent polls to conserve power, given the reduced chance that the next poll will produce a likelihood score greater than threshold likelihood score TH.

Processing then loops back to operation 82 and the external object sensor gathers an additional segment of sensor data SENS using the updated/adjusted polling period P. Once the output of neural network 48 exceeds threshold likelihood score TH, processing proceeds from operation 86 to operation 96 via path 94.

At operation 96, external object sensor 26 outputs an object detection signal indicative of the detection of object 50 (e.g., indicative of object 50 exhibiting the predetermined characteristic). Control circuitry 14 may perform any desired processing operations based on the object detection signal (e.g., the continuous transmission of NFC signals and the beginning of communications with an NFC-enabled tag or card, an NFC-enabled financial transaction, an adjustment to antenna transmit power level, a user input operation based on a gesture detection, other software and/or hardware operations, etc.).

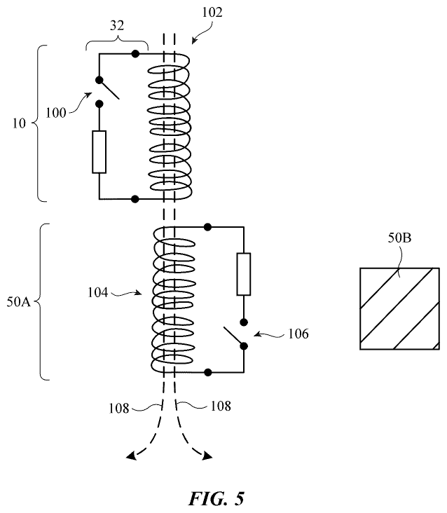

FIG. 5 is a diagram showing how device 10 interacts with an external object using NFC circuitry 32 (FIG. 1). As shown in FIG. 5, device 10 may include NFC circuitry 32 operably coupled to a corresponding coil 102. Coil 102 is sometimes also referred to herein as NFC coil 102. NFC circuitry 32 may drive a current on coil 102 that produces radio-frequency signals (e.g., in signal 52 of FIG. 1) such as a corresponding magnetic field 108 (e.g., at a 13.56 MHZ carrier frequency or another frequency). NFC circuitry 32 may modulate wireless data onto the signals (e.g., by performing carrier modulation using on-off switching with switch 100, carrier amplitude modulation, etc.).

The objects 50 around device 10 may include a first object 50A that has NFC capabilities (e.g., an RFID tag, RFID/NFC reader, etc.). Object 50A may therefore have an NFC coil such as coil 104. Coil 104 is coupled to NFC circuitry 106. NFC circuitry 106 may include one or more switches, an NFC integrated circuit (IC), etc. When device 50A is brought into the vicinity of device 10 (e.g., with coil 104 overlapping coil 102), magnetic field 108 induces a corresponding current in coil 104 (e.g., as signal 52 of FIG. 1). The current in coil 104 may power NFC circuitry 106. When powered, NFC circuitry 106 may actively change the load impedance of coil 104 as a function of time (e.g., by toggling one or more switches in a predetermined pattern as controlled by the integrated circuit, thereby load modulating magnetic field 108). NFC circuitry 32 on device 10 may detect the change in impedance (load modulation) of coil 104 via coil 102 (e.g., as signal 54 of FIG. 1). NFC circuitry 32 may process the change in impedance to authenticate device 50A, to determine that device 50A is an RFID tag or NFC-enabled device, to perform a transaction, etc.

When performing object detection, the signal received by NFC circuitry 32 via coil 102 may be processed (e.g., using neural network 48) to distinguish object 50A (e.g., an authenticated device having NFC/RFID capabilities) from other objects without RFID/NFC functionality such as metallic object 50B (e.g., a metallic foreign object). In this example, the predetermined characteristic of device 50 detected during object detection (e.g., as characterized by likelihood score σ) is that object 50A is a device with NFC/RFID capabilities rather than a metallic object 50B without NFC/RFID capabilities or some other object. Using the dynamic polling scheme of FIG. 3 to detect object 50A may serve to decrease the latency with which device 10 detects object 50A and/or to increase the minimum distance R between device 10 and object 50A before which device 10 is able to accurately detect that object 50A is object 50A rather than metallic object 50B. In implementations where object 50A is used to perform a financial transaction with device 10 by tapping object 50A over device 10, the intelligence of neural network 48 may allow a person holding object 50A to perform the transaction while holding, tapping, or swiping object 50A over device 10 from a farther distance R (e.g., twice the distance or greater) than when a baseband receiver chain without a neural network is used, for example.

In this example, device 10 is a proximity coupling device (PCD) such as an NFC initiator/reader device or a device having NFC initiator/reader functionality) and device 50A is a proximity inductive coupling card (PICC). This is illustrative and non-limiting. If desired, object 50A may be a PCD whereas device 10 is a PICC. If desired, both device 10 and object 50A may be PCDs.

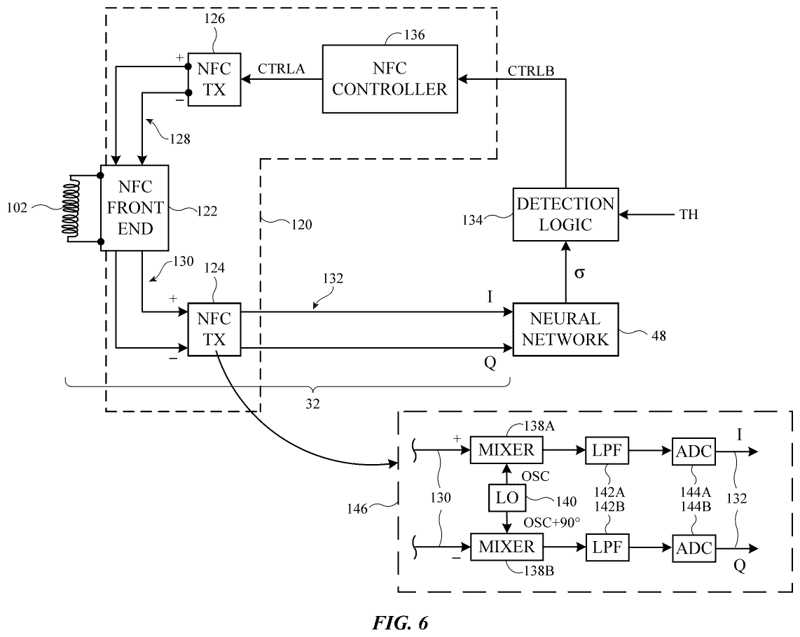

FIG. 6 is a circuit diagram showing how NFC circuitry 32 on device 10 may provide sensor data to neural network 48 for detecting object 50. As shown in FIG. 6, NFC circuitry 32 may include an NFC transmitter (TX) 126, an NFC receiver (RX) 124, an NFC front end 122 coupled to coil 102, and an NFC controller 136 (e.g., one or more processors of the processing circuitry on device 10). The output of NFC TX 126 may be coupled to NFC front end 122 over signal path 128 (e.g., a signal path 31 of FIG. 1). The input of NFC RX 124 may be coupled to NFC front end 122 over signal path 130 (e.g., a signal path 31 of FIG. 1).

NFC controller 136 may provide control signals CTRLA to NFC TX 126 that cause NFC TX 126 to transmit radio-frequency signals over coil 102. NFC front end circuitry 122 may include filter circuitry, impedance matching circuitry, and/or any other desired front end circuitry. NFC TX 126 may include a digital-to-analog converter, amplifier circuitry, filter circuitry, mixer circuitry (e.g., for upconverting from baseband to NFC frequencies), and/or other transmitter circuitry. If desired, NFC TX 126 may modulate wireless data onto the transmitted radio-frequency signals. Control signals CTRLA may, for example, control NFC TX 126 to poll the radio-frequency signals with a corresponding polling period P (e.g., by transmitting the radio-frequency signals in pulses 78 of FIG. 3).

NFC RX 124 may receive radio-frequency signals from coil 102 and NFC front end 122 (e.g., during pulses 78 of FIG. 3). The received signals may include wireless data transmitted by object 50A of FIG. 5 (e.g., via load modulations and/or other signal modulations). Portion 146 of FIG. 6 shows one example implementation of NFC RX 124. As shown by portion 146 of FIG. 6, NFC RX 124 may include a first mixer 138A and a second mixer 138B coupled to signal path 130. NFC RX 124 may include an oscillator such as local oscillator (LO) 140. LO 140 generates an oscillator signal OSC. LO 140 provides oscillator signal OSC to mixer 138A and a version of oscillator signal OSC that is phase shifted by 90 degrees to mixer 128B.

Mixer 138A downconverts the signal received over signal path 130 using oscillator signal OSC and provides the downconverted signal to low pass filter (LPF) 142A. Mixer 138B downconverts the signal received over signal path 130 using the version of oscillator signal OSC that has been phase shifted by 90 degrees and provides the downconverted signal to low pass filter (LPF) 142B. Low pass filters 142A and 142B filter out higher radio frequency signal components from the downconverted signals (e.g., WLAN and/or cellular telephone signal components). Analog-to-digital converters (ADCs) 144A and 144B may convert the downconverted and filtered signals to the digital domain and may output the digital signals as digital in-phase (I) and quadrature-phase (Q) data on output path 132. This is illustrative and, in general, NFC RX 124 may have any desired NFC receiver architecture.

The output of NFC RX 124 may be coupled to the input of neural network 48 over digital path 132 (e.g., an I/Q path that carries the I/Q data). Neural network 48 may receive the I/Q data (e.g., sensor data SENS of FIG. 1) over I/Q path 132. NFC RX 124 may, for example, provide the I/Q data directly to neural network 48 without any decoding, processing, or pre-processing of the I/Q data prior to receipt at neural network 48 (e.g., without any processing blocks, demodulation blocks, decoding blocks, processing blocks, or pre-processing blocks such as fast Fourier Transform blocks that convert the I/Q signal from the time domain into the frequency domain, in NFC RX 124 or on I/Q path 132). The I/Q data received at neural network 48 may, for example, be time domain data that is un-demodulated (e.g., that includes data that is still modulated) and un-decoded (e.g., that includes data that is still encoded). Neural network 48 may generate an output (e.g., likelihood score σ) based on the I/Q data (e.g., while processing operation 84 of FIG. 4). Neural network 48 may output likelihood score σ to detection logic 134 (e.g., logic gates, one or more comparators, etc.). Detection logic 134 may compare likelihood score 134 to threshold likelihood score TH and may output the object detection signal when likelihood score σ exceeds threshold TH.

Detection logic 134 may transmit a control signal CTRLB to NFC controller 136. Control signal CTRLB may include the object detection signal and/or likelihood score σ. Control signal CTRLB may control NFC controller 136 to update polling period P based likelihood score σ and/or based on whether likelihood score σ exceeds threshold TH (e.g., while iterating over operations 86, 90, and 82 of FIG. 4). While shown as separate from neural network 48 for the sake of clarity, detection logic 134 may form a part of neural network 48 if desired.

If desired, NFC front end 122, NFC TX 126, NFC RX 124, and NFC controller 136 may be integrated into a shared NFC module or package 120 (e.g., on a shared substrate such as a printed circuit, package substrate, etc.). Neural network 48 and detection logic 134 may be formed as an integral part of NFC module 120 or may be separate from NFC module 120.

Consider an example in which the external object sensor 26 used to detect object 50 is NFC circuitry 32 (FIG. 1). NFC technology generally requires an active NFC reader (e.g., on device 10) to generate a radio-frequency field to power up a passive NFC/RFID tag (e.g., object 50A of FIG. 5) that stores data such as identification information on a corresponding integrated circuit (IC) chip or memory (e.g., NFC circuitry 106 of FIG. 5). This can restrict NFC communications to situations in which the NFC reader must provide enough energy to the tag to support operation of the IC and/or to situations in which the NFC tag includes at least some digital memory and an NFC modulation/demodulation module to communicate with the NFC reader. Due to such limitations, a mobile NFC reader device generally requires a tag detection phase (e.g., prior to entering a full power communications mode) during which the NFC reader device transmits on/off polling signals at a relatively low transmit power level. In the tag detection phase or during low power card detection (LPCD), the tag does not generally require energy to power its IC. Therefore, even during the polling pulse, the transmit power can be set much lower than when the reader is performing data communication with the tag.

If care is not taken, polling for a long amount of time can cause device 10 consume excessive energy, limiting battery life. For example, if the NFC reader polls using a constant relatively low polling period such as polling period PA of FIG. 3, the NFC reader will transmit a high amount of polling signals until the NFC tag is presented in sufficient proximity to device 10 such that communications (e.g., bidirectional conveyance of wireless data) can begin between the NFC reader and the NFC tag. To save power, the polling period can be much sparser, such as polling period PB of FIG. 3, and/or the radio-frequency signals transmitted by the NFC reader can be pulsed at relatively low power levels. However, because such pulses are infrequent and low power, the NFC tag will not be woken up (e.g., will not be powered by magnetic field 108 of FIG. 5) until the NFC tag is very close to the NFC reader.

Generally, when the NFC receiver on the NFC reader includes a direct downconversion architecture, the downconverted waveform is fed into a digital baseband and contains subtle signal information on loading changes produced by the NFC tag. Once the NFC reader has detected the presence of the NFC tag, the NFC reader enters a full power operating mode with nonstop continuous NFC signal transmission at higher transmit power levels than during the tag detection phase, thereafter performing communications with the NFC tag.

In practice, it is challenging to successfully decode the subtle pulse waveform at the NFC reader to detect the presence of the NFC tag. For example, other objects such as metallic object 50B (FIG. 5) in proximity to the NFC reader can also cause loading changes as seen at the NFC reader. False detection can significantly reduce the power saving benefit of polling with low power and a long polling period. On the other hand, if the decoding algorithm is tuned to minimize false detection, this can compromise detection distance for the NFC tag. Since there is no straightforward overall transfer function from presentation of the NFC tag to digital baseband waveform variation (e.g., due to an excessive number of contributing variables), significant processing resources are often required to adjust the decoding algorithm.

Unlike using fixed digital baseband processing on the I/Q data output by NFC RX 124, neural network 48 may provide sufficient processing depth to recover the subtle features contained within the received NFC waveform. This may allow device 10 to detect the presence of the NFC reader (e.g., as the predetermined characteristic of object 50) at a greater distance R and with lower false detection rate (and thus lower power consumption) than when neural network 48 is omitted from external object sensor(s) 26. Neural network 48 may be trained using a large quantity of waveform data along with truth labels to produce optimized weight functions (e.g., weight function W of FIG. 2) rather than requiring a time-consuming manual design of the waveform decoding algorithm.

Further, neural network 48 may allow the NFC circuitry 32 on device 10 to extend its object detection beyond NFC tags, allowing the NFC circuitry to also recognize, distinguish, or detect other physical objects that are not necessarily equipped with an NFC tag IC. For example, NFC circuitry 32 and neural network 48 may identify physical objects having different materials, since the metallic properties of different objects can be recognized through machine learning-based object recognition via NFC circuitry 32 and neural network 48. In these examples, each type of object (e.g., aluminum object, copper object, NFC credit card, NFC tag, etc.) may be represented by a corresponding class output by the final classifier stage 66 in neural network 48 (FIG. 2).

As another example, NFC circuitry 32 and neural network 48 may detect external objects 50A that are chip-less (e.g., chip-less tags where the tag is designed to exhibit unique variations in radio-frequency properties that are detected by NFC circuitry 32 and neural network 48 and that serve as a unique physical identifier for the tag). Such chip-less tags are much less expensive to manufacture and require much less radio-frequency power from device 10 to be recognized/detected. In addition, device 10 may balance latency with power consumption by dynamically adjusting polling period P based on the output of neural network 48 as produced in response to waveforms received/measured by NFC circuitry 32.

For example, transmitting RF pulses using NFC TX 126 consumes considerable power. For battery powered devices, it may be necessary to limit power consumption by transmitting the pulses with long polling periods (e.g., turning NFC circuitry 32 off or to a low power mode between pulses 78 of FIG. 3). However, setting the polling frequency too low increases detection latency (e.g., as shown in plot 72 of FIG. 3). The dynamic polling period P selected based on the softmax output of neural network 48 (e.g., likelihood score σ) serves to simultaneously optimize latency and power consumption.

In an example where the predetermined characteristic detected by neural network 48 is the presence of an NFC tag (e.g., where object 50/50A is an NFC-enabled credit card), polling with a fixed polling period will either suffer from high detection latency (e.g., as shown by plot 72 in FIG. 3) or excessive power consumption due to frequency polling (e.g., as shown by plot 70 of FIG. 3). Since the NFC tag has to move toward device 10 before it can be detected, and such movement speed is limited by the kinematics of the user's hand motion, some amount of time is required before the NFC tag passes to a position such that neural network 48 is able to output a likelihood score greater than threshold likelihood score TH. During this time, likelihood score σ generally increases from zero (e.g., as shown by curve 76 of FIG. 3 after time T1). NFC controller 136 may then begin to increase polling frequency based on the likelihood score σ from the previous poll (or from a combination or average of the previous poll with one or more earlier polls). Even though the initial polling period can be set to be relatively long, the polling period may be dynamically shortened as likelihood score σ increases, and latency becomes very low from the time likelihood score σ reaches threshold TH until a next poll detects the NFC tag. This may be extended to other uses cases such as precision detection distance (e.g., where threshold TH can be adjusted to fine tune object detection distance if a precise detection distance is desired), movement tracking (e.g., due to the increased polling frequency while the object is approaching, object position and movement speed information can be extracted from abundant likelihood scores associated with multiple adjacent polls), and/or other use cases.

Neural network 48 may be trained using any desired neural network or machine learning training algorithms. Neural network 48 may be trained prior to use of device 10 by an end user (e.g., during design, manufacturing, assembly, testing, and/or calibration of device 10 in a design, manufacturing, assembly, testing, and/or calibration system). This process is sometimes referred to herein as offline training. Additionally or alternatively, neural network 48 may be trained during use of device 10 by an end user in a process sometimes referred to herein as online training.

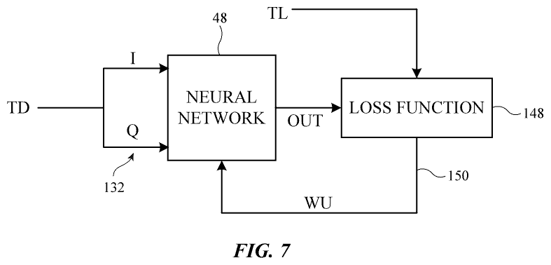

FIG. 7 is a diagram showing of one example of how neural network 48 may be trained offline. As shown in FIG. 7, neural network 48 may receive training data TD as I/Q data over I/Q path 132. Neural network 48 may generate an output OUT based on training data TD and may provide output OUT to loss function block 148. Loss function block 148 may receive a training label TL (e.g., near-field object presence information). The training data TD (e.g., an I/Q ADC output waveform) and training label TL may be pre-acquired from a large number of data samples in a training set. Training label TL may be 1 when training data TD corresponds to the presence of an NFC tag and may be 0 when training data TD corresponds to the absence of an NFC tag, for example.

Loss function block 148 may compare training label TL to output OUT (e.g., using a loss calculation mechanism such as a cross entropy loss function). The loss calculated by loss function 148 is then averaged over all data samples and fed back to neural network 48 via path 150 (e.g., as weight updating signal WU) and neural network 48 performs a back-propagation process to effectively update its weights W from the last layer up to the first layer. This process is iterated until the loss function is reduced to a very small value, which infers an overall detection result sufficiently close to ground truth. The training data set can be obtained through a real hardware bench and/or simulation models. If the model is fully representative of the hardware and radio-frequency properties, model data can largely support the training process and save bench data collection time. Further, the training process can be performed with a neural network model or an actual neural engine hardware.

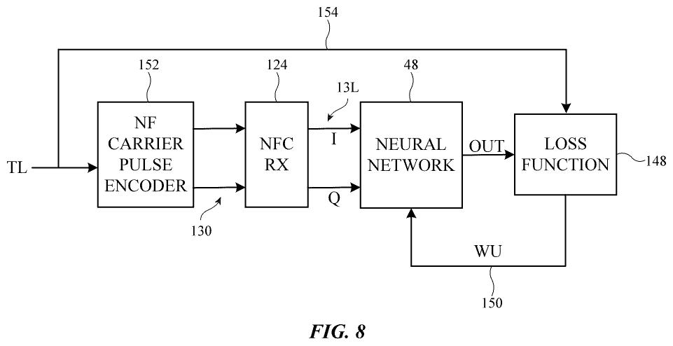

FIG. 8 is a diagram showing of one example of how neural network 48 may be trained online. As shown in FIG. 8, NFC RX 124 may receive training label TL via NFC carrier pulse encoder 152, which provides actual online data to NFC RX 124 over signal path 130. Training label TL is also passed to loss function 148 over bypass path 154 (e.g., around encoder 152, NFC RX 124, and neural network 48).

Unlike offline training, the training data is not pre-obtained during offline training. Instead, the training data is generated during device operation (e.g., at NF carrier pulse encoder 152). Therefore, the back-propagation process across different data samples needs to be sequential rather than in parallel. Generally, online training is performed after neural network 48 has already been sufficiently trained offline using a large data set. In these situations, the online training may be used to improve performance with certain corner data as not well covered during offline training.

If desired, neural network 48 may be used to detect or track the movement of object 50 to detect a predetermined gesture or action performed by object 50. Consider an example in which object 50 is an NFC-enabled object 50A (FIG. 5) such as a credit card having an NFC tag. The dynamic polling described above may further allow device 10 to perform object position and movement tracking by analyzing the likelihood scores of multiple polls. When the polling frequency increases at closer distances, device 10 may detect position and movement of object 50 with finer granularity or higher precision. This may, for example, be used to perform a movement triggered transaction using object 50 (e.g., when a user swipes object 50 over the NFC coil on device 10 to perform a transaction with device 10 such as a financial transaction).

In some scenarios, the only criteria to trigger the transaction is the relative position of object 50 over device 10. However, in practice, a user can accidentally place object 50 into the interrogating zone of the NFC reader (e.g., within a predetermined distance R from device 10) in a manner that incorrectly or wrongly triggers the transaction. For NFC card emulation devices such as NFC-enabled wristwatches or phones, the devices may require an additional input from the user such as a button press or face scan to confirm the transaction and to prevent falsely triggered transactions. However, by tracking the movement of object 50 using neural network 48, device 10 may detect a predetermined gesture motion of object 50 relative to device 10 that can serve as a confirmation or trigger for the transaction and that otherwise minimizes the occurrence of an incorrectly triggered transaction.

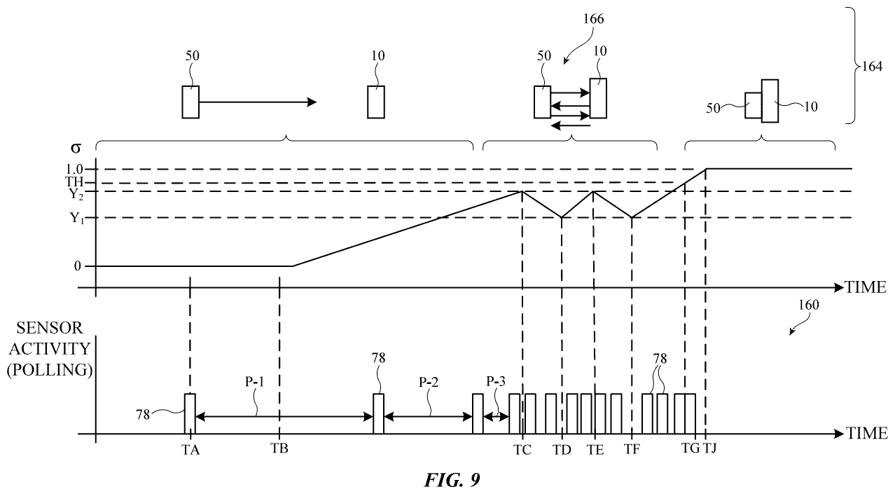

FIG. 9 is a timing diagram showing how neural network 48 and NFC circuitry 32 on device 10 (e.g., a device having NFC capabilities, a point of sale terminal, etc.) may perform recognition of a predetermined motion of object 50 (e.g., to serve as a transaction confirmation when object 50 is an NFC-enabled device or a credit card having an integrated NFC tag).

Portion 164 of FIG. 9 illustrates the relative position of object 50 and device 10 at different times. Curve 162 of FIG. 9 plots the likelihood score σ generated by neural network 48 in response to polling by NFC circuitry 32 on device 10 (as shown by pulses 78 in plot 160 of FIG. 9). As shown in FIG. 9, prior to time TA, object 50 is located relatively far from device 10, causing neural network 48 to output a likelihood score of σ=0.

At time TB, device 50 passes within a threshold distance R (FIG. 1) of device 10. At the next poll (e.g., the pulse 78 that is polling period P-1 after time TA), neural network 48 outputs a likelihood score of 0<σ<<TH. The increase in likelihood score σ causes device 10 to decrease the polling period of NFC circuitry 32 to period P-2.

Beginning at time TC, the user of object 50 may begin to move object 50 in a predetermined movement pattern relative to device 10. For example, the user may rapidly move object 50 back and forth between a first position relative to device 10 and a second position that is farther from device 10 than the first position, as shown by arrows 166. When at the first position, neural network 48 outputs a likelihood score σ=Y1. When at the second position, neural network 48 outputs a likelihood score of σ=Y2>Y1.

The decrease in likelihood score from time TC to time TD, associated with movement of object 50 from the first position to the second position, causes neural network 48 to increase polling period P. The increase in likelihood score from time TD to time TE, associated with movement of object 50 from the second position to the first position, causes neural network 48 to decrease polling period P. The decrease in likelihood score from time TE to time TF, associated with movement of object 50 from the second position back to the first position, causes neural network 48 to increase polling period P.

At time TG, the user moves object 50 close enough to device 10 to produce a likelihood score greater than threshold TH (e.g., up to a likelihood score around 1.0 at time TJ). NFC circuitry 32 may enter a full power operating mode with nonstop continuous NFC signal transmission at higher transmit power levels after time TJ (e.g., thereafter performing communications with object 50). Control circuitry 14 may process the likelihood score σ as a function of time prior to passing threshold TH to determine whether the likelihood score is associated with a predetermined gesture or motion by the user, such as a gesture that serves to confirm a transaction. Control circuitry 14 may compare the change in likelihood score σ as a function of time to a set of one or more stored patterns of likelihood score σ as a function of time such as a stored pattern associated with a gesture that serves as a transaction confirmation. If the predetermined pattern in likelihood score σ is detected, device 10 may confirm that the user of object 50 intended to complete a transaction when moving object 50 close enough to device 10 to raise likelihood score σ over threshold TH, and may proceed with completing or executing the transaction. The decrease in polling period after time TC may allow device 10 to gather a sufficient number of likelihood scores σ to be able to measure the rapid changes in distance between device 10 and object 50 associated with the gesture. The example of FIG. 9 is illustrative and non-limiting. The NFC circuitry may be replaced by any external object detection sensor 26 on device 10.

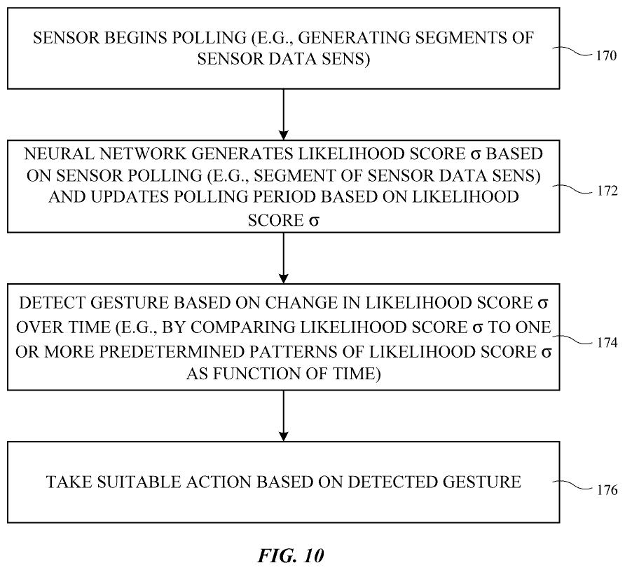

FIG. 10 is a flow chart of operations involved in using neural network 48 to detect a gesture from the motion of object 50 (e.g., for confirming a transaction between device 10 or the user of device 10 and object 50 or the user of object 50).

At operation 170, external object sensor 26 may begin polling with an initial polling period P (e.g., generating segments of sensor data SENS).

At operation 172, neural network 48 begins generating likelihood scores σ based on each segment of sensor data SENS as the object sensor performs object detection polling. Control circuitry 14 (e.g., detection logic 134 and NFC controller 136) may update or adjust polling period P based on likelihood score σ.

At operation 174, control circuitry 14 may detect a predetermined motion or gesture of object 50 based on the likelihood score σ generated by neural network 48 as a function of time. For example, control circuitry 14 may detect the repeated variation/oscillation of likelihood score σ between values Y1 and Y2 (e.g., a predetermined number of repetitions) in the likelihood score σ generated by neural network 48 as a function of time. This is illustrative and non-limiting. In general, control circuitry 14 may detect any repeated movement of object 50 relative to device 10 and/or the movement of object 50 in any desired predetermined pattern (e.g., gesture motion) relative to device 10 based on the likelihood score output by neural network 48.

At operation 176, device 10 may take any desired action based on the detected gesture. The detected gesture may serve as a user input, a transaction confirmation, or any other desired input to device 10.

While some examples of object detection are described herein in connection with NFC circuitry 32, similar operations may be performed by any of external object sensors 26 (FIG. 1). The object detection algorithm may be optimized, for example, to detect events that do not occur all the time (e.g., object presence, a monitored parameter reaching a limit, etc.), but once such an event happens there occurs a pre-warming phase (e.g., where the object approaches from a distance before it is fully presented, the monitored parameter increasing before reaching the limit, etc.), when overall power consumption is a factor (e.g., where the sensor needs to be off or idle most of the time and only turns on to poll periodically), when detection latency is a factor (e.g., where polling frequency cannot be set too low), etc. The techniques described herein can be applied to any desired sensors on device 10 (e.g., any of sensors 26 of FIG. 1). If desired, the sensors may include other types of sensors such as quantity sensors (e.g., chemical sensors or other quantity sensors as long as the sensor output has a warning stage and is able to interface with a neural network).

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Devices 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. An electronic device comprising:
a coil;
a near-field communications (NFC) transmitter operably coupled to the coil;
an NFC receiver operably coupled to the coil, the NFC receiver being configured to receive a radio-frequency waveform using the coil;
a neural network operably coupled to the NFC receiver and configured to generate a likelihood score based on the radio-frequency waveform; and
processing circuitry configured to detect an object based on the likelihood score.

2. The electronic device of claim 1, wherein the object comprises a radio-frequency identification (RFID) tag.

3. The electronic device of claim 1, wherein the likelihood score comprises a softmax output.

4. The electronic device of claim 1, wherein the NFC receiver is configured to generate in-phase and quadrature-phase (I/Q) data based on the radio-frequency waveform, the neural network being configured to generate the likelihood score based on the I/Q data.

5. The electronic device of claim 1, wherein the NFC transmitter is configured to transmit radio-frequency signals associated with the radio-frequency waveform using a polling period, the processing circuitry being configured to adjust the polling period based on the likelihood score.

6. The electronic device of claim 1, wherein the likelihood score has a first value when the object has an NFC coil and has a second value when the object has no NFC coils.

7. A method of operating an electronic device comprising:
receiving, using a near-field communications (NFC) transceiver operably coupled to a coil, a radio-frequency waveform via the coil;
generating, using a neural network operably coupled to the NFC receiver, a likelihood score based on the radio-frequency waveform; and
detecting, using processing circuitry, an object based on the likelihood score.

8. The method of claim 7, wherein the object comprises a radio-frequency identification (RFID) tag.

9. The method of claim 7, wherein generating the likelihood score comprises generating a softmax output based on the radio-frequency waveform and wherein detecting the object comprises detecting the object based on the softmax output.

10. The method of claim 7, further comprising:
generating, using the NFC receiver, in-phase and quadrature-phase (I/Q) data based on the radio-frequency waveform.

11. The method of claim 10, further comprising:
generating, using the neural network, the likelihood score based on the I/Q data.

12. The method of claim 7, further comprising:
transmitting, at an NFC transmitter operably coupled to the coil, a radio-frequency signal associated with the radio-frequency waveform using a polling period.

13. The method of claim 12, further comprising:
adjusting, using the processing circuitry, the polling period based on the likelihood score.

14. The method of claim 7, wherein the likelihood score has a first value when the object has an NFC coil and has a second value when the object has no NFC coils.

15. An electronic device comprising:
a transmitter configured to transmit one or more radio-frequency signals;
a receiver configured to receive a waveform; and
processing circuitry configured to
generate a likelihood score based on the received waveform, the likelihood score being associated with an external device, and
detect a gesture associated with the external device based on a change in the likelihood score over time.

16. The electronic device of claim 15, wherein the processing circuitry comprises a neural network configured to generate the likelihood score.

17. The electronic device of claim 15, wherein the transmitter is configured to transmit the one or more radio-frequency signals using a polling period, the processing circuitry being further configured to:
detect a repeated variation of the likelihood score; and
adjust the polling period concurrent with the repeated variation of the likelihood score.

18. The electronic device of claim 17, wherein the processing circuitry is further configured to:
increase and decrease the polling period concurrent with the repeated variation of the likelihood score.

19. The electronic device of claim 15, wherein the transmitter is operably coupled to a coil and is configured to transmit the one or more radio-frequency signals using the coil, the receiver being operably coupled to the coil and being configured to receive the waveform via the coil.

20. The electronic device of claim 18, wherein the likelihood score is associated with a near-field communications (NFC) device and the external device is the NFC device.
